(19) United States
(12) Patent Application Publication
(10) Pub. No.: US 2026/0056226 A1
(43) Pub. Date: Feb. 26, 2026

(54) MICROELECTROMECHANICAL SENSOR COMPONENT AND MICROELECTROMECHANICAL INERTIAL SENSOR

(71) Applicant: Robert Bosch GmbH, Stuttgart (DE)

(72) Inventor: Johannes Classen, Reutlingen (DE)

(21) Appl. No.: 19/288,326

(22) Filed: Aug. 1, 2025

(30) Foreign Application Priority Data
Aug. 22, 2024 (DE) 10 2024 207 999.5

(51) Int. Cl. G01P 15/125; G01P 15/08; H04R 19/04

(52) U.S. Cl. CPC G01P 15/125; H04R 19/04; G01P 2015/0874; G01P 2015/0882; H04R 2201/003

(57) ABSTRACT

A microelectromechanical sensor component. The component includes: a substrate; a movable sensor structure connected to the substrate and having a seismic mass portion and a deflection electrode arranged thereon; and at least one evaluation electrode arranged on the substrate. The deflection electrode is arranged so as to be movable relative to the evaluation electrode. The evaluation electrode is configured for capacitive detection of a deflection of the deflection electrode. The deflection electrode and the evaluation electrode form a comb structure. The deflection electrode has a plurality of deflection electrode fingers extending from a deflection electrode bar in the direction of the evaluation electrode. The evaluation electrode has a plurality of evaluation electrode fingers extending, parallel at least in portions to the deflection electrode fingers, from an evaluation electrode bar in the direction of the deflection electrode.

### CROSS REFERENCE

The present application claims the benefit under 35 U.S.C. § 119 of Germany Patent Application No. DE 10 2024 207 999.5 filed on Aug. 22, 2024, which is expressly incorporated herein by reference in its entirety.

### FIELD

The present invention relates to a microelectromechanical sensor component. The present invention further relates to a microelectromechanical inertial sensor.

### BACKGROUND INFORMATION

Certain microelectromechanical sensor components and certain microelectromechanical inertial sensors are described in the related art. Microelectromechanical systems are also abbreviated as MEMS.

For example, for the sensory detection of accelerations, it is conventional to detect deflections of a movable sensor element of a microelectromechanical sensor component capacitively. For example, a relative movement between a movable electrode connected to a seismic mass and an immovable electrode can be detected by a change in capacitance.

According to a first sensing principle, for example, a change in spacing between a fixed electrode bar and an electrode bar movable toward and/or away from the fixed electrode bar can be capacitively detected. Such an electrode configuration with variable electrode spacing can be advantageous in terms of high electrode sensitivity, in particular for small electrode spacings. High electrode sensitivity can contribute to high electrical sensitivity of the sensor component. At the same time, high damping can be achieved if the electrode bars are arranged in a defined gas atmosphere, since a change in the spacing between the electrode bars can be associated with squeeze film damping, which can generate high damping forces. With high damping, for example, signal interference caused by vibration excitation can be effectively suppressed.

According to a second sensing principle, an electrode configuration with a comb structure can be provided in which electrode fingers of an immovable electrode and electrode fingers of a movable electrode connected to a seismic mass mesh in a comb-like manner and are displaced parallel to one another upon deflection of the seismic mass. A changing lateral overlap of the electrode fingers can be detected as a capacitive measurement signal. Such an electrode configuration may have a lower electrode sensitivity than an electrode configuration according to the first sensing principle described above, but it can be operated with a possibly desired low damping since, in such an electrode configuration, sliding film damping with lower damping forces between the electrode fingers dominates over squeeze film damping.

Germany Patent Application No. DE 10 2006 059 928 A1 describes a micromechanical capacitive acceleration sensor with at least one seismic mass deflectably connected to a substrate, at least one electrode fixedly connected to the substrate and at least one electrode connected to the seismic mass, wherein the at least one electrode fixedly connected to the substrate and the at least one electrode connected to the seismic mass are designed as comb electrodes with lamellae running parallel to the deflection direction of the seismic mass, wherein the lamellae of both comb electrodes partially overlap in the rest state.

### SUMMARY

According to the present invention, a microelectromechanical sensor component is provided. According to an example embodiment of the present invention, the microelectromechanical sensor component comprises a substrate, a movable sensor structure connected to the substrate and having a seismic mass portion and a deflection electrode arranged thereon, and at least one evaluation electrode arranged on the substrate, the deflection electrode of the movable sensor structure being arranged so as to be movable relative to said evaluation electrode, wherein the evaluation electrode is configured for capacitive detection of a deflection of the deflection electrode, wherein the deflection electrode and the evaluation electrode form a comb structure in that the deflection electrode has a plurality of deflection electrode fingers extending from a deflection electrode bar in the direction of the evaluation electrode, and in that the evaluation electrode has a plurality of evaluation electrode fingers extending, parallel at least in portions to the deflection electrode fingers, from an evaluation electrode bar in the direction of the deflection electrode, wherein the deflection electrode fingers have a finger length in the direction of the evaluation electrode bar that corresponds to at most three times a finger spacing from a lateral surface of a deflection electrode finger to an opposite lateral surface of an adjacent evaluation electrode finger, and/or wherein the evaluation electrode fingers have a finger length in the direction of the deflection electrode bar that corresponds at most to three times a finger spacing from a lateral surface of an evaluation electrode finger to an opposite lateral surface of an adjacent deflection electrode finger.

In simple terms, it is proposed to provide a sensor component with an electrode comb structure with comparatively short, compactly dimensioned electrode fingers. Illustrated visually, the compact dimensioning is intended to achieve more of a tooth structure than a finger structure.

The microelectromechanical sensor component according to the proposed features has the advantage of an area-saving, space-saving, and mechanically robust design with high electrical sensitivity and reduced noise of the microelectromechanical sensor component.

The microelectromechanical sensor component presents a technical approach that can combine the advantages of the above-described first sensing principle and the above-described second sensing principle. Due to the comparatively weak comb structure, the sensor component can use a combined sensing principle from the first and second sensing principles to achieve high electrode sensitivity and low damping in favor of an optimized signal-to-noise ratio of the sensor component. The compact, closely intermeshed electrode fingers of the evaluation and deflection electrodes make a combined sensing principle possible in that a change in the spacing between the electrode bars themselves, between the electrode bars and the end surfaces of the electrode fingers, as well as a variable overlap between the electrode fingers can be used in combination to detect an acceleration force acting on the movable sensor structure. While the comb fingers in a comb structure with pronounced comb fingers contribute to a high total capacitance, but only a small change in capacitance is associated with the change in the overlap length of the comb fingers during the deflection, a lower total capacitance can also be achieved with the shortened comb fingers so that the electrode sensitivity is thereby increased.

The electrical sensitivity of the microelectromechanical sensor component is not reduced or is only moderately reduced compared to an electrode arrangement according to the first sensing principle, but the squeeze film damping is significantly reduced. The specific geometric design can be varied within defined parameters as required in order to influence the properties of the sensor component in a targeted manner and to adapt them to an intended application of the sensor component. In addition, possible applications of the microelectromechanical sensor component can be considered that, for example, cannot be implemented with the conventional sensing principles due to conflicting requirements. For example, as explained in more detail below, the proposed microelectromechanical sensor component can be used in combination with other components that require high damping, but increased mechanical noise associated with the high damping should not significantly impair the sensor component.

With the microelectromechanical sensor component of the present invention, very low electronic and mechanical noise power densities can be achieved so that, for example, a low-noise inertial sensor can be formed with the microelectromechanical sensor component. Here, a mechanical noise power density refers to Brownian noise due to statistical collisions and a resulting momentum transfer between the seismic mass and surrounding gas molecules. With low damping, the mechanical noise power density can be reduced. The electronic noise power density can be reduced with high electrical sensitivity. Since the proposed microelectromechanical sensor component of the present invention can combine high electrical sensitivity with low damping, a low overall noise of the sensor component can thus be achieved. In some applications, noise reduction may be prioritized over reduced vibration sensitivity through high damping, for example in headphone and headset applications. If the microelectromechanical sensor component is used in combination with a further sensor component in a common measuring chamber of an inertial sensor, the further sensor component can be designed with a high damping for high vibration robustness and the measuring chamber can be subjected to a corresponding internal pressure without the noise behavior of the proposed microelectromechanical sensor component being significantly impaired, since the damping forces in the proposed electrode arrangement are reduced by the basic comb structure, but the electrical sensitivity is not too strongly influenced by the reduced design of the comb fingers. In other words, the microelectromechanical sensor component can be arranged together with a further, highly damped sensor component in a common sensor cavity at a comparatively high internal pressure and still be characterized by low-noise sensor signals.

When considering the proposed microelectromechanical sensor component of the present invention, it must also be noted that, due to the microelectromechanical dimensions and a limited chip area for implementing the sensor component, the electrical sensitivity cannot simply be increased by enlarging the sensing structures; rather, intelligent design solutions must be developed to optimize the utilization of the physical laws in the smallest possible space, as is implemented here by moving away from elongated comb finger structures with a high range of motion toward compact tooth-shaped comb geometries. The compact design and improved area utilization can, for example, provide a smaller and/or more cost-effective sensor, or the additional area gained can be used to increase the seismic mass and/or the electrical sensitivity in favor of noise reduction.

A microelectromechanical sensor component can, for example, be a component that is produced with semiconductor technology and has mechanical and electrical microstructures. A microelectromechanical sensor component can be suitable for implementation as a system-on-chip (SoC) due to its microstructural design. As a sensor component, the microelectromechanical sensor component can, for example, be configured to detect physical quantities. The sensor component described in the context of this application can be configured in particular for the direction-dependent detection of an acceleration or rotation rate, which are referred to below collectively as acceleration in the sense of a translational or rotational acceleration.

According to an example embodiment of the present invention, the substrate can be a flat semiconductor carrier structure. The substrate can be a silicon wafer, for example. The substrate has two mutually opposite substrate surfaces that can be referred to as a front side and a rear side. The front side of the substrate can form an active side of the substrate, on which side the mechanical and electrical microstructures of the sensor component are arranged.

In this case, a movable sensor structure is understood to be a mechanically coherent microstructural unit for detecting a physical quantity, in particular acceleration. For example, the movable sensor structure can be deflectable from a defined rest position so that a deflection of the sensor structure relative to the rest position can be used to detect the physical quantity. A seismic mass portion can be a mechanical mass portion of the sensor structure that is configured to interact with the quantity to be detected and primarily serves to deflect the movable sensor structure. A deflection electrode can be an electrically conductive electrode element mechanically connected to the seismic mass portion, which electrode element is configured for capacitive interaction with the evaluation electrode and primarily serves to electrostatically detect the deflection of the movable sensor structure. The seismic mass portion can have a greater mass than the deflection electrode. The seismic mass portion can enclose the deflection electrode in a frame-like manner. The seismic mass portion can have two frame legs running parallel to each other, between which the deflection electrode, in particular a deflection electrode bar of the deflection electrode, runs substantially perpendicular to the frame legs so that the frame legs and the deflection electrode form an H shape. In principle, a plurality of deflection electrodes can also be arranged on the seismic mass portion. These deflection electrodes can, for example, extend parallel to one another between the frame legs of the seismic mass portion. The seismic mass portion can be connected to the substrate via a spring element. The spring element allows defined deflection and resetting of the seismic mass portion. In other words, the movable sensor structure can be elastically deflected. By appropriately designing the spring element, one or more deflection directions of the movable sensor structure can be specified by the design. The movable sensor structure is in particular configured to be movable parallel to a substrate surface of the substrate. Such a sensor structure is also referred to as a laterally movable or horizontally movable sensor structure and is to be distinguished from a vertically effective sensor structure, simply referred to as a z-sensor structure, which is configured to deflect away from or toward the substrate. The deflection electrode has a deflection electrode bar. The deflection electrode bar can be a straight, bar-shaped electrode portion. Deflection electrode fingers protrude laterally from the deflection electrode bar. The deflection electrode fingers are spaced apart from one another, in particular evenly spaced apart from one another, so that there is a gap between adjacent deflection electrode fingers in each case. According to one embodiment, deflection electrode fingers can protrude on both sides of the deflection electrode bar along its main extent. In this embodiment, each deflection electrode finger can have at least one adjacent deflection electrode finger on the same side of the deflection electrode bar and an opposite deflection electrode finger on the opposite side of the deflection electrode bar.

Furthermore, according to an example embodiment of the present invention, at least one evaluation electrode is arranged on the substrate, the deflection electrode being arranged so as to be movable relative to said evaluation electrode. In particular, the evaluation electrode can be an electrically conductive, fixed electrode element which, compared to the deflection electrode, is immovably fixed to the substrate. The evaluation electrode is configured to capacitively detect a deflection of the deflection electrode through electrostatic interaction with the deflection electrode. In addition to its mechanical connection to the substrate, the evaluation electrode can have an electrical connection to a conductor track arranged on the substrate, in order to make tapping of the capacitive measurement signal of the evaluation electrode in interaction with the deflection electrode possible. A plurality of evaluation electrodes, which can be assigned individually or in pairs to one or more deflection electrodes, can also be arranged on the substrate. The evaluation electrode has an evaluation electrode bar. The evaluation electrode bar can be a straight, bar-shaped electrode portion. Evaluation electrode fingers protrude laterally from the deflection electrode bar. The evaluation electrode fingers are spaced apart from one another, in particular evenly spaced apart from one another, so that there is a gap between adjacent evaluation electrode fingers in each case. According to one possible design, the evaluation electrode bar can have a shorter length parallel to the deflection electrode bar than the deflection electrode bar.

According to an example embodiment of the present invention, the deflection electrode and the evaluation electrode form a comb structure in that the deflection electrode fingers and the evaluation electrode fingers extend alternately parallel to one another. In other words, the deflection electrode fingers extend into the gaps between the evaluation electrode fingers, and the evaluation electrode fingers extend into the gaps between the deflection electrode fingers. The deflection electrode fingers and the evaluation electrode fingers can therefore be interlaced in a comb-like manner. The deflection electrode fingers point to the evaluation electrode bar of the evaluation electrode, and the evaluation electrode fingers point to the deflection electrode bar of the deflection electrode. Due to the relative mobility of the deflection electrode, the engagement of the evaluation electrode fingers in the gaps between the deflection electrode fingers and the engagement of the deflection electrode fingers in the gaps between the evaluation electrode fingers can increase or decrease during a deflection so that the electrode fingers in each case can extend further or less into the gaps or can be displaced toward or away from the corresponding opposite electrode bar.

According to an example embodiment of the present invention, there is a finger spacing in each case between the deflection electrode fingers and the evaluation electrode fingers, which extend parallel and adjacent to one another. In other words, it is provided that the deflection electrode fingers and evaluation electrode fingers do not touch one another but are spaced apart from one another in a defined manner. The finger spacing is substantially unchanged during a deflection since the electrode fingers are substantially moved parallel to one another when the deflection electrode is deflected.

The deflection electrode fingers have a defined finger length. The finger length can refer to an extent of a deflection electrode finger between the deflection electrode bar and the evaluation electrode bar in the direction of which the deflection electrode finger points. The evaluation electrode fingers also have a defined finger length. The finger length can refer to an extent of an evaluation electrode finger between the evaluation electrode bar and the deflection electrode bar in the direction of which the evaluation electrode finger points.

According to the proposed features of the present invention, the deflection electrode fingers can have a finger length in the direction of the evaluation electrode bar that corresponds at most to three times a finger spacing from a lateral surface of the deflection electrode finger to an opposite lateral surface of an adjacent evaluation electrode finger, and/or the evaluation electrode fingers can have a finger length in the direction of the deflection electrode bar that corresponds at most to three times a finger spacing from a lateral surface of the evaluation electrode finger to an opposite lateral surface of an adjacent deflection electrode finger. Since the finger spacing between adjacent electrode fingers is kept as small as possible for technical reasons in order to achieve a pronounced capacitive measurement signal and good use of installation space, such dimensioning means a significant shortening of the electrode fingers in question compared to the extensively elongated electrode fingers usually found in the related art. Instead of a pronounced comb structure, the interlacing of the deflection electrode with the evaluation electrode can therefore be viewed as a toothing for better illustration. This allows the above-described advantages of an area-saving, space-saving, and mechanically robust design with high electrical sensitivity and reduced noise of the microelectromechanical sensor component to be achieved. In particular, the microelectromechanical sensor component is characterized by significantly improved noise characteristics with reduced mechanical and electrical noise power densities. The compact, closely intermeshed electrode fingers of the evaluation and deflection electrodes make a combined sensing principle possible in that a change in the spacing between the electrode bars themselves, between the electrode bars and the end surfaces of the electrode fingers, as well as a variable overlap between the electrode fingers can be used in combination to detect an acceleration force acting on the movable sensor structure.

According to one possible design of the present invention, the finger lengths of the evaluation electrode fingers and the deflection electrode fingers can be substantially the same. According to one possible design, the finger spacings between the evaluation electrode fingers and the deflection electrode fingers can be substantially the same. If the deflection electrode has deflection electrode fingers extending on both sides of the deflection electrode bar, the finger lengths of the deflection electrode fingers and/or the finger spacings to adjacent evaluation electrode fingers on both sides of the deflection electrode bar can be substantially the same.

According to one example embodiment of the present invention, at least two evaluation electrodes can be arranged spaced apart from one another on the substrate, between which evaluation electrodes the deflection electrode of the movable sensor structure is movably arranged, wherein the evaluation electrodes are configured for differential capacitive detection of a deflection of the deflection electrode. This allows a more accurate measurement signal to be obtained with the microelectromechanical sensor component. When the movable sensor structure is deflected, the deflection electrode can be deflected toward one of the two evaluation electrodes and away from the other evaluation electrode, and vice versa, so that both evaluation electrodes detect opposing capacitance changes that can be evaluated differentially. In this embodiment, the deflection electrode can have a deflection electrode bar with deflection electrode fingers extending on both sides of the deflection electrode bar in the direction of the evaluation electrodes. The deflection electrode fingers can have the same finger lengths and/or the same finger spacings on both sides of the deflection electrode bar. If the deflection electrode fingers on both sides of the deflection electrode bar have a finger length in the direction of the corresponding opposite evaluation electrode bar that corresponds to at most three times the finger spacing from one lateral surface of the deflection electrode finger to an opposite lateral surface of an adjacent evaluation electrode finger, the advantages described above can be deployed in interaction with both evaluation electrodes. In particular, a particularly compact microelectromechanical sensor component with a favorable signal-to-noise ratio can be provided. If the movable sensor structure has a plurality of deflection electrodes, a plurality of evaluation electrodes can accordingly be assigned in pairs to each deflection electrode.

According to one example embodiment of the present invention, adjacent evaluation electrode fingers and deflection electrode fingers can have a defined overlap length parallel to one another in a rest state of the movable sensor structure, wherein the overlap length is at most twice as large as the finger spacing between an evaluation electrode finger and an adjacent deflection electrode finger. This allows not only the electrode fingers but also an overlapping region thereof to be kept compact and dimensioned so as to promote improved electrical sensitivity and reduced total capacitance. In particular, with a small overlap length, damping of the electrode arrangement is significantly reduced. According to an example embodiment of the present invention, the sliding film damping on the overlapping lateral surfaces of the electrode fingers is almost negligible due to the short overlap length. The dominant damping contribution is caused by squeeze film effects on the end surfaces of the electrode fingers. However, the gas squeezed at the end surfaces can easily escape to the lateral surfaces of the electrode fingers. The small overlap length also has the advantage that the capacitance on the lateral surfaces of the electrode fingers is low without thereby impairing the electrical sensitivity. Relevant for the electronic noise of the capacitance/voltage conversion of an evaluation circuit of the microelectromechanical sensor component is the quotient of electrical sensitivity, which is proportional to the electrode sensitivity, and the sum of the relevant useful and parasitic capacitances. High electrode sensitivity combined with low useful capacitance is generally advantageous. The overlap length can be regarded as a distance between the deflection electrode bar and the evaluation electrode bar along which there is a parallel extent of a deflection electrode finger and an evaluation electrode finger. A rest state of the movable sensor structure refers to a state in which no acceleration force acts on the movable sensor structure and the deflection electrode is not deflected in the direction of an evaluation electrode. According to one possible design of the present invention, the overlap length can be at most 1.75 times as large as the finger spacing between an evaluation electrode finger and an adjacent deflection electrode finger.

According to one example embodiment of the present invention, in a rest state of the movable sensor structure, a defined first finger end spacing may be present between an end surface of an evaluation electrode finger facing the deflection electrode bar and the deflection electrode bar, wherein the finger length of the evaluation electrode finger is at most four times as large as the first finger end spacing. Alternatively or additionally, in a rest state of the movable sensor structure, a defined second finger end spacing may be present between an end surface of a deflection electrode finger facing the evaluation electrode bar and the evaluation electrode bar, wherein the finger length of the deflection electrode finger is at most four times as large as the second finger end spacing. Accordingly, in addition to the smallest possible finger spacing, a relatively short finger end spacing can be provided. As a result, a particularly compact microelectromechanical sensor component can be provided. In addition, the small finger end spacing means that the end surfaces of the electrode fingers also contribute significantly to a capacitive detection signal. The overall sensitivity of the sensor structure can therefore result as the sum of the overlap change at the lateral surfaces of the electrode fingers and the change in the spacing at the end surfaces. A small finger end spacing can be associated with reduced mobility of the deflection electrode. However, since the proposed sensor component allows the change in spacing between the electrode bars, the change in spacing between the finger end surfaces and the opposite electrode bar, as well as the variable overlap length of the electrode fingers to be used for the measurement signal, the reduced mobility is not associated with any significant limitation in terms of measurement quality. In addition, reduced mobility can contribute to increased robustness of the sensor component. According to an advantageous possible design, the finger length of the evaluation electrode finger can be at most three times as large as the first finger end spacing. According to an advantageous possible design, the finger length of the deflection electrode finger can be at most three times as large as the second finger end spacing. An electrode finger can have two lateral surfaces, each facing a further electrode finger, and an end surface facing an opposite electrode bar to which the electrode finger is not connected. The spacing between the end surface and a surface of the opposite electrode bar facing the electrode finger can be referred to as the first or second finger end spacing.

According to one example embodiment of the present invention, adjacent evaluation electrode fingers and deflection electrode fingers can have a defined overlap length parallel to one another in a rest state of the movable sensor structure, wherein, in a rest state of the movable sensor structure, a defined first finger end spacing is present between an end surface of an evaluation electrode finger facing the deflection electrode bar and the deflection electrode bar, wherein the overlap length is at most twice as large as the first finger end spacing, and/or wherein, in a rest state of the movable sensor structure, a defined second finger end spacing is present between an end surface of a deflection electrode finger facing the evaluation electrode bar and the evaluation electrode bar, wherein the overlap length is at most twice as large as the second finger end spacing. This allows not only the electrode fingers but also an overlapping region thereof to be kept compact and dimensioned so as to promote improved electrical sensitivity and reduced total capacitance, in particular if a comparatively short finger end spacing is selected as described above. According to one possible design, the overlap length can be at most 1.75 times, in particular at most 1.5 times, as large as the first finger end spacing and/or as the second finger end spacing.

According to one example embodiment of the present invention, the finger spacing can correspond to the first finger end spacing and/or the second finger end spacing with a maximum deviation of 50%, in particular with a maximum deviation of 25%. Accordingly, a spacing between adjacent electrode fingers can be similar or of the same dimension as a finger end spacing between an end surface of an electrode finger and of an opposite electrode bar not connected to the electrode finger. This provides a particularly space-efficient and robust microelectromechanical sensor component with a favorable compact arrangement of the deflection electrode and of the evaluation electrode with regard to capacitive measurement signals.

According to one example embodiment of the present invention, the first finger end spacing can correspond to the second finger end spacing with a maximum deviation of 50%, in particular with a maximum deviation of 25%. In other words, the deflection electrode fingers and the evaluation electrode fingers can each have substantially the same spacings from the opposite electrode bars so that uniform interlacing can be achieved. According to one possible design, the finger spacing, the first finger end spacing and the second finger end spacing can be substantially of the same dimension, i.e., have a maximum deviation of 50%, in particular a maximum deviation of 25%. This allows the capacitive measuring behavior to be optimized, and the advantages of the different combined measuring principles of the sensor component are better utilized due to the reduced comb structure with uniform spacings between the electrode structures. In particular, with such dimensioning, the end surfaces of the electrode fingers can provide just as large a signal contribution as the lateral surfaces of the electrode fingers. For this purpose, in particular the finger spacing, the first finger end spacing, the second finger end spacing, the finger width and the overlap length of the electrode fingers can have substantially the same dimension.

According to one example embodiment of the present invention, the finger length of the evaluation electrode fingers can be at most twice, in particular at most 1.5 times, as large as a finger width of the evaluation electrode fingers perpendicular to their finger length, and/or the finger length of the deflection electrode fingers can be at most twice, in particular at most 1.5 times, as large as a finger width of the deflection electrode fingers perpendicular to their finger length. In other words, a finger width of the electrode fingers can also be advantageously dimensioned in relation to the finger length such that a compact, tooth-shaped electrode structure is formed. A narrow finger width also allows more electrode fingers to be arranged on the deflection electrode and/or on the evaluation electrode and to contribute to a pronounced capacitive measurement signal. According to one possible design, the finger length of the evaluation electrode fingers can be at most 1.75 times, in particular at most 1.5 times, as large as a finger width of the evaluation electrode fingers perpendicular to their finger length, and/or the finger length of the deflection electrode fingers can be at most 1.75 times, in particular at most 1.5 times, as large as a finger width of the deflection electrode fingers perpendicular to their finger length.

According to one example embodiment of the present invention, the finger length of the evaluation electrode fingers can be at least as large as the finger width of the evaluation electrode fingers perpendicular to their finger length, and/or the finger length of the deflection electrode fingers can be at least as large as the finger width of the deflection electrode fingers perpendicular to their finger length. Accordingly, a minimum length of the electrode fingers defined in relation to the finger width can be provided in order to limit the proposed shortening of the electrode fingers to a technically reasonable extent. In particular, shortening the electrode fingers too much may have the effect that the above-described squeeze film damping increases to such an extent that it causes a dominating damping effect with high damping forces so that the center of gravity is shifted very far in the direction of the first sensing principle and the combination of the two sensing principles can no longer be optimally utilized. Since the finger width cannot be selected too small for sufficient robustness of the electrode structure, this represents a useful reference value for defining a minimum length of the electrode finger.

According to one example embodiment of the present invention, the finger width of the evaluation electrode fingers and/or of the deflection electrode fingers can be at least half and at most twice the overlap length. This also makes it possible to achieve a favorable design and arrangement of the electrode fingers for a pronounced capacitive measurement signal.

According to one example embodiment of the present invention, the finger length of the evaluation electrode fingers can correspond at least to the finger spacing from one lateral surface of the evaluation electrode finger to an opposite lateral surface of an adjacent evaluation electrode finger, and/or the finger length of the deflection electrode fingers can correspond at least to the finger spacing from one lateral surface of the deflection electrode finger to an opposite lateral surface of an adjacent evaluation electrode finger. Accordingly, a minimum length of the electrode fingers defined in relation to the finger spacing can be provided in order to limit the proposed shortening of the electrode fingers to a technically reasonable extent. In particular, shortening the electrode fingers too much may have the effect that the above-described squeeze film damping increases to such an extent that it causes a dominating damping effect with high damping forces so that the center of gravity is shifted very far in the direction of the first sensing principle and the combination of the two sensing principles can no longer be optimally utilized. Since the finger spacing cannot be selected too small for a capacitive measurement, this represents a useful reference value for defining a minimum length of the electrode finger.

According to one example embodiment of the present invention, a spacing between two successive deflection electrode fingers can correspond to a maximum of twice the finger length of the deflection electrode fingers, and/or a spacing between two successive evaluation electrode fingers can correspond to a maximum of twice the finger length of the evaluation electrode fingers. Accordingly, comparatively small spacings can be provided between the electrode fingers of the deflection electrode and/or of the evaluation electrode in order to be able to arrange as many electrode fingers as possible on them, which contribute to a more pronounced capacitive measurement signal. The close and compact arrangement of the electrode fingers also makes it possible to provide an overall comparatively small microelectromechanical component. According to one possible design, a spacing between two successive deflection electrode fingers can correspond to a maximum of 1.5 times the finger length of the deflection electrode fingers, and/or a spacing between two successive evaluation electrode fingers can correspond to a maximum of 1.5 times the finger length of the evaluation electrode fingers.

According to one example embodiment of the present invention, the finger spacing can be between 0.5 and 2.5 μm. Accordingly, a finger spacing from one lateral surface of the evaluation electrode finger to an opposite lateral surface of an adjacent deflection electrode finger can be between 0.5 and 2.5 μm. This allows for a favorable spacing of the electrode fingers for measurement technology in microelectromechanical dimensions in order to achieve a pronounced capacitive measurement signal with a low pull-in risk. In addition, such spacings can be precisely produced using semiconductor manufacturing processes.

According to one example embodiment of the present invention, the finger length of the deflection electrode fingers may be smaller than a diameter of the deflection electrode bar transverse to its main extent, and/or the finger length of the evaluation electrode fingers may be smaller than a diameter of the evaluation electrode bar transverse to its main extent. Accordingly, each electrode bar as a support structure can have a comparatively larger extent in a direction of extent of the electrode fingers so that the compact character of the comb structure becomes clear in relation. The pronounced electrode bar with short electrode fingers allows for a robust and metrologically optimized microelectromechanical sensor component to be obtained. A main extent can generally refer to a longest direction of extent. The diameter of each electrode bar can be measured in its direction of extent, which coincides with a direction of extent of an electrode finger starting from the electrode bar to an opposite electrode bar.

According to one example embodiment of the present invention, the movable sensor structure can be configured to deflect the deflection electrode in such a way that the deflection electrode bar is movable toward the evaluation electrode bar. Accordingly, the described microelectromechanical sensor component can in particular have a laterally movable sensor structure in which the electrode bars are movable toward and away from one another instead of parallel to one another. In particular, the described microelectromechanical sensor component can be configured to detect an acceleration in a defined horizontal spatial direction.

According to one example embodiment of the present invention, the microelectromechanical sensor component can comprise a sensor cavity in which the movable sensor structure and the evaluation electrode are arranged, wherein a predefined gas pressure is set in the sensor cavity. This allows the movable sensor structure and the evaluation electrode to be arranged in a protected manner and operated under defined environmental conditions. In particular, the damping properties of the sensor cavity can be precisely adjusted by means of the predefined gas pressure and adapted to a specific application of the sensor component.

According to a development of the present invention, a further sensor element with a movable detection structure for detecting an acceleration acting on the microelectromechanical sensor component can be arranged in the sensor cavity. Accordingly, a plurality of sensing units can be arranged in the sensor cavity. The movable detection structure may be similar or identical to the above-described movable sensor structure or may have a different structure and/or a different functional principle. In particular, the further sensor element can be a sensor element that is to be operated with a high damping due to the requirements, so that the predefined gas pressure in the sensor cavity is to be set comparatively high. Due to the above-described advantages of the proposed microelectromechanical sensor component, which include, for example, reduced mechanical noise due to the design-related reduced damping and, at the same time, high electrical sensitivity due to the change in spacing between the end surfaces of the electrode fingers and the electrode bars that can be detected in addition to the variable overlap length, the microelectromechanical sensor component can also be operated with a further sensor element in a strongly damped environment with high measurement accuracy, although the internal pressure of the sensor cavity would normally have to be significantly reduced to achieve low noise values. The highly damped environment can, for example, be required for a further sensor element that has to be designed to be particularly robust against vibration. With the proposed microelectromechanical sensor component, it is no longer necessary to provide separate sensor cavities for the movable sensor structure and the movable detection structure of the further sensor element in order to meet the different required measurement conditions.

According to one example embodiment of the present invention, the microelectromechanical sensor component can have a plurality of movable sensor structures and associated evaluation electrodes. This allows for efficient use of installation space and makes it possible to increase the measurement accuracy. For example, the deflection electrodes can be arranged parallel to one another and can each be surrounded by two evaluation electrodes. The deflection electrodes can be arranged on a common seismic mass.

The present invention also relates to a microelectromechanical inertial sensor having a microelectromechanical sensor component according to one of the above-described features and having a signal processing unit for applying and processing signals of the microelectromechanical sensor component. The microelectromechanical inertial sensor of the present invention can also achieve the above-described advantages of an area-saving, space-saving, and mechanically robust design with high electrical sensitivity and reduced noise of the microelectromechanical inertial sensor. The microelectromechanical inertial sensor can be designed, for example, as an acceleration sensor for detecting a translational acceleration and/or as a rotation rate sensor for detecting a rotational acceleration. The microelectromechanical inertial sensor can be configured in particular to detect an acceleration in a horizontal spatial direction with a lateral deflection of the sensor structure parallel to the substrate surface. The functional principle of microelectromechanical inertial sensors is based, due to their microstructure, on very small mechanical deflections of the seismic mass element that can be detected capacitively but are associated with correspondingly weak measurement signals. With a microelectromechanical inertial sensor having a microelectromechanical sensor component according to the proposed features of the present invention, an inertial sensor with high measurement accuracy and a favorable signal-to-noise ratio can be provided. A signal processing unit can have a control circuit, which can be designed in particular as an integrated circuit, for example as an ASIC (application-specific integrated circuit). The signal processing unit is configured to apply and/or process signals of the microelectromechanical sensor component and can, for example, be used to receive and evaluate sensor signals of the microelectromechanical sensor component and to perform control tasks.

According to one example embodiment of the present invention, the microelectromechanical inertial sensor can be designed to detect structure-borne sound, in particular bone conduction, and/or airborne sound. Due to its high sensitivity in a very small installation space, even very weak sound waves can be reliably sensed. In particular, the microelectromechanical sensor component of the inertial sensor can be designed to detect bone conduction, it being possible to provide a particularly low-noise bone conduction detector on account of the design of the sensor component with the proposed features and according to the optional embodiments. Due to its compact design and high sensitivity, the microelectromechanical inertial sensor is advantageously suitable for use close to the body, allowing for comfortable and reliable bone conduction detection. Such bone conduction detection can, for example, be advantageously used in modern wireless earphones or headsets.

For example, the signals of the sensor component that detects bone conduction can be offset against simultaneously recorded microphone signals, for example to allow for active noise suppression. If the microelectromechanical sensor component is used with the movable sensor structure and a further sensor element in the same sensor cavity, the movable sensor structure can, for example, be used as a bone conduction sensor, while the further sensor element can be used for activity detection or rotation rate detection, for example for 3D audio applications.

In principle, it is possible to use the described microelectromechanical sensor component, for example, in an acceleration sensor, a rotation rate sensor, or a resonator.

The described microelectromechanical sensor component of the present invention and/or the described microelectromechanical inertial sensor of the present invention can be used, for example, in the automotive and/or consumer sectors, for example in miniaturized hearables such as earphones, earbuds or true wireless stereo headsets.

The described microelectromechanical sensor component of the present invention and/or the described microelectromechanical inertial sensor of the present invention can be used, for example, in connection with smartphones and tablets, wearables, hearables, smart glasses, smart contact lenses, augmented reality, virtual reality, drones, gaming, toys, robots, the smart home and, for example, in an industrial context, amongst other things for the following further applications: wake-up functions for selected device modules, detection of device orientation, screen orientation and display orientation, detection of a significant movement, shock and free-fall detection; HMI (human-machine interface) functionality, e.g., multi-tap detection, activity, gesture and context recognition, bone conduction detection, user recognition, voice recognition, keyword recognition; movement control, Cardan system, height and position stabilization, flight control, image stabilization, indoor and outdoor navigation, floor recognition, position tracking and route recording, PDR (pedestrian dead reckoning), dynamic route planning, detection of boundaries and obstacles, indoor SLAM (simultaneous localization and mapping); intrusion monitoring, real-time movement recognition and tracking, activity tracking, pedometer, calorie counter, sleep monitoring; detection of the wearing state of hearables (in-ear/out-of-ear detection), determination of head orientation and head movement; logistics, parts tracking, energy management and energy-saving measurement, predictive maintenance; sensor data fusion.

The present invention can furthermore be used in connection with automobile applications, e.g., with regard to: crash detection, e.g., in airbag systems; electronic stability programs (ESP), vehicle dynamics control (VDC); hill start assist, hill hold control (prevention of rolling back when starting off on inclines); adaptive chassis control; smart tires, e.g., road condition monitoring; road noise cancellation; navigation applications; autonomous driving; theft detection, alarm functions; monitoring tailgate tilt; optimization of engine control and of the combustion process in gasoline or diesel engines.

The described microelectromechanical sensor component of the present invention and/or the described microelectromechanical inertial sensor of the present invention can be suitable for production in a mass production process due to their fundamentally simple design.

The described microelectromechanical sensor component of the present invention has been presented here in conjunction with capacitive measuring principles. Due to the underlying electrostatic principles, it is fundamentally not excluded to use the above-described features for a microelectromechanical actuator component with an electrostatic drive in order to provide a microelectromechanical actuator component with a particularly compact drive structure.

In general, in the context of this application, the words “a/an,” unless expressly defined otherwise, are not to be understood as numerals, but as indefinite articles with the literal meaning of “at least one.” The present invention allows for various embodiments and is explained in more detail below using exemplary embodiments with the figures.

### BRIEF DESCRIPTION OF THE DRAWINGS

FIG. 1 is a schematic diagram of a microelectromechanical sensor component according to a first embodiment of the present invention in a plan view.

FIG. 2A shows a comb structure of a microelectromechanical sensor component according to a first embodiment variant according to the related art.

FIG. 2B shows a comb structure of the microelectromechanical sensor component according to a second embodiment variant of the present invention.

FIG. 2C shows a comb structure of the microelectromechanical sensor component according to a third embodiment variant of the present invention.

FIG. 3 is a schematic diagram of a microelectromechanical sensor component according to a second embodiment of the present invention in a plan view.

FIG. 4 is a schematic diagram of a microelectromechanical inertial sensor having a microelectromechanical sensor component, according to an example embodiment of the present invention.

### DETAILED DESCRIPTION OF EXAMPLE EMBODIMENTS

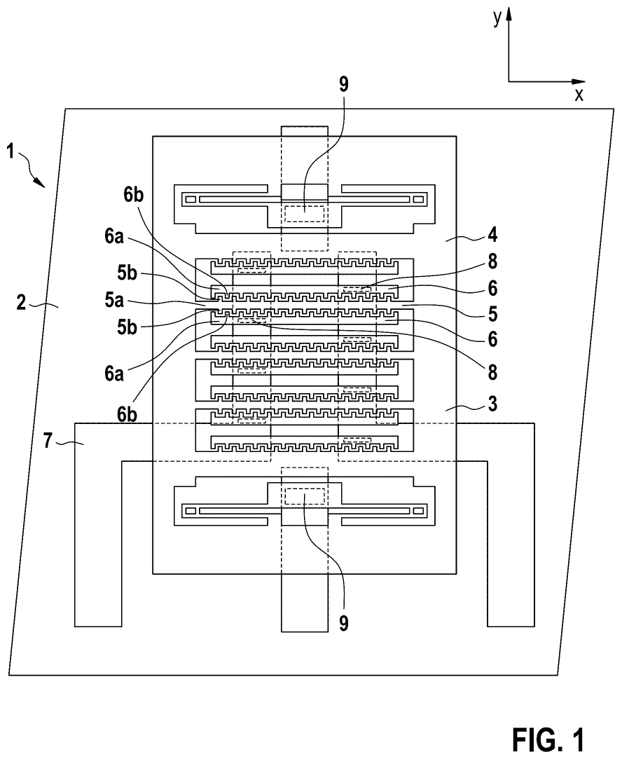

FIG. 1 shows a schematic diagram of a microelectromechanical sensor component 1. The microelectromechanical sensor component 1 has a substrate 2. In addition, the microelectromechanical sensor component 1 has a movable sensor structure 3 connected to the substrate 2 via spring elements 9 and having a seismic mass portion 4 and deflection electrodes 5 arranged thereon. The seismic mass portion 4 frames the deflection electrodes 5 in a frame-like manner and has two frame legs running parallel to each other, between which the deflection electrode bars 5a of the deflection electrodes 5 run parallel to one another. Furthermore, the microelectromechanical sensor component 1 has evaluation electrodes 6 arranged on the substrate 2, which evaluation electrodes are assigned in pairs to each deflection electrode 5 and enclose it between them. For this purpose, two evaluation electrodes 6 are arranged spaced apart from each other, and the deflection electrode 5 of the movable sensor structure 3 is arranged movably between the evaluation electrodes 6. The evaluation electrodes 6 are configured for differential capacitive detection of a deflection of the deflection electrodes 5 and are electrically connected via conductor track connections 8 to a conductor track structure 7 arranged on the substrate 2. The conductor track structure 7 can be insulated from the substrate 2 via a dielectric insulation layer, not shown in detail, for example an oxide and/or nitride layer.

According to the exemplary embodiment described below, the microelectromechanical sensor component 1 is configured to detect a horizontal acceleration force acting parallel to a surface of the substrate 2. According to the horizontal spatial direction axes shown in FIG. 1, a detection of an acceleration in the y-direction is provided according to the electrode arrangement shown, since the deflection electrodes 5 are arranged to be movable toward and away from the evaluation electrodes 6 flanking the deflection electrodes 5. The microelectromechanical sensor component 1 shown in FIG. 1 can have a sensor cavity (not shown in detail) in which the movable sensor structure 3 and the evaluation electrodes 6 are arranged, wherein a predefined gas pressure is set in the sensor cavity.

As can be seen in FIG. 1, the deflection electrodes 5 and the evaluation electrodes 6 assigned to them in each case form a comb structure in that the deflection electrodes 5 have a plurality of deflection electrode fingers 5b extending from a deflection electrode bar 5a in the direction of the evaluation electrodes 6 and in that the evaluation electrodes 6 have a plurality of evaluation electrode fingers 6b extending from an evaluation electrode bar 6a in the direction of the deflection electrode 5 at least in portions parallel to the deflection electrode fingers 5b.

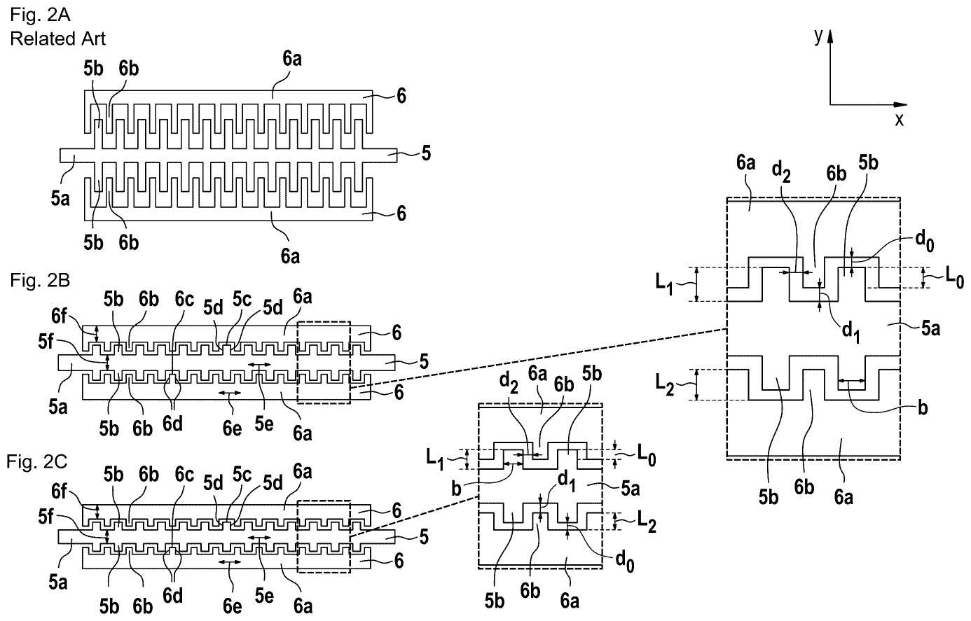

FIG. 2A to 2C show different embodiment variants for such a comb structure of the microelectromechanical sensor component 1.

FIG. 2A shows a first embodiment variant according to the related art. The finger-like comb structure with elongated deflection electrode fingers 5b and elongated evaluation electrode fingers 6b can be clearly seen. It can also be seen that the deflection electrode fingers 5b have a large spacing from the opposite evaluation electrode bars 6a and that the evaluation electrode fingers 6b have a large spacing from the opposite deflection electrode bars 5a. With the comb structure shown in FIG. 2A, a second sensing principle of a microelectromechanical sensor component 1 can be implemented, in which, upon deflection of the movable sensor structure 3, a changing lateral overlap of the deflection electrode fingers 5b and the evaluation electrode fingers 6b is detected as a capacitive measurement signal. The comb structure shown in FIG. 2A is characterized by low damping but also low electrode sensitivity, which can impair the electronic noise power density of the microelectromechanical sensor component 1.

FIG. 2B shows a second embodiment variant for the comb structure of the microelectromechanical sensor component 1, wherein an enlarged view of a marked portion of the comb structure is additionally shown. It can be seen from the enlarged view that the deflection electrode fingers 5b have a finger length L₁ in the direction of the evaluation electrode bars 6a that corresponds at most to three times a finger spacing d₂ from a lateral surface 5d of a deflection electrode finger 5b to an opposite lateral surface 6d of an adjacent evaluation electrode finger 6b. In addition, the evaluation electrode fingers 6b have a finger length L₂ in the direction of the deflection electrode bar 5a that corresponds at most to three times a finger spacing d₂ from a lateral surface 6d of an evaluation electrode finger 6b to an opposite lateral surface 5d of an adjacent deflection electrode finger 5b. Due to the comparatively short finger lengths L₁, L₂, a microelectromechanical sensor component 1 with a very compact, tooth-shaped comb structure can be provided, which can be designed to be area-saving, space-saving, and mechanically robust and has a high electrical sensitivity and a very good signal-to-noise ratio.

With regard to the microelectromechanical dimensioning of the sensor component 1, the finger spacing d₂ can, for example, be between 0.5 and 2.5 μm, which allows for a metrologically favorable spacing of the electrode fingers with a low pull-in risk. As can also be seen in FIG. 2B, adjacent evaluation electrode fingers 6b and deflection electrode fingers 5b have a defined overlap length L₀ parallel to one another when the movable sensor structure 3 is in a rest state. According to the exemplary embodiment shown, the overlap length L₀ is at most twice as large as the finger spacing d₂ between an evaluation electrode finger 6b and an adjacent deflection electrode finger 5b so that a compact overlapping region is obtained that promotes improved electrical sensitivity and reduced total capacitance.

Furthermore, it can be seen in FIG. 2B that, in a rest state of the movable sensor structure 3, a defined first finger end spacing d₁ is present between an end surface 6c of an evaluation electrode finger 6b facing the deflection electrode bar 5a and the deflection electrode bar 5a. The finger length L₂ of the evaluation electrode finger 6b is at most four times as large as the first finger end spacing d₁. In addition, in a rest state of the movable sensor structure 3, a defined second finger spacing d₀ is present between an end surface 5c of a deflection electrode finger 5b facing the evaluation electrode bar 6a and the evaluation electrode bar 6a. The finger length L₁ of the deflection electrode finger 5b is at most four times as large as the second finger end spacing d₀. The small finger end spacings d₁, d₀ not only create a compact sensor component 1, but the end surfaces 5c, 6c of the electrode fingers also contribute significantly to the capacitive detection signal. The finger length L₂ of the evaluation electrode fingers 6b and the finger length L₁ of the deflection electrode fingers can correspond to at least the finger spacing d₂, as shown. In addition, the overlap length L₀ is at most twice as large as the first finger end spacing d₁ and as the second finger end spacing d₀. The first finger end spacing d₁ and the second finger end spacing d₂ can be substantially the same. The first finger end spacing d₁ and the second finger end spacing d₀ can substantially correspond to the finger spacing d₂ or can be slightly larger, in particular can be dimensioned with a maximum deviation of between 25 and 50% corresponding to the extent of the finger spacing d_{2.}

As can be seen in FIG. 2B, the finger length L₂ of the evaluation electrode fingers 6b is at least as large and at most twice as large as a finger width b of the evaluation electrode fingers 6b perpendicular to their finger length L₂. In addition, the finger length L₁ of the deflection electrode fingers 5b is at least as large and at most twice as large as a finger width b of the deflection electrode fingers 5b perpendicular to their finger length L₁. The finger width b of the evaluation electrode fingers 6b and of the deflection electrode fingers 5b can be at least half and at most twice the overlap length L₀. As shown, a spacing between two successive deflection electrode fingers 5b can correspond to a maximum of 1.5 times the finger length L₁ of the deflection electrode fingers 5b, and/or a spacing between two successive evaluation electrode fingers 6b can, as shown, correspond to a maximum of 1.5 times the finger length L₂ of the evaluation electrode fingers 6b. According to the exemplary embodiment shown, the finger length L₁ of the deflection electrode fingers 5b is smaller than a diameter 5f of the deflection electrode bar 5a transverse to its main extent 5e. In addition, the finger length L₂ of the deflection electrode fingers 6b is smaller than a diameter 6f of the deflection electrode bar 6a transverse to its main extent 6e.

FIG. 2C shows a third embodiment variant for the comb structure of the microelectromechanical sensor component 1, wherein an enlarged view of a marked portion of the comb structure is additionally shown. The enlarged view shows that the deflection electrode fingers 5b have a finger length L₁ in the direction of the evaluation electrode bars 6a that corresponds to at most twice a finger spacing d₂ from a lateral surface 5d of a deflection electrode finger 5b to an opposite lateral surface 6d of an adjacent evaluation electrode finger 6b. In addition, the evaluation electrode fingers 6b have a finger length L₂ in the direction of the deflection electrode bar 5a that corresponds at most to twice a finger spacing d₂ from a lateral surface 6d of an evaluation electrode finger 6b to an opposite lateral surface 5d of an adjacent deflection electrode finger 5b. This allows the technical effect described in FIG. 2B to be further enhanced in order to promote a further optimized signal-to-noise ratio. The finger spacing d₂ can, for example, be between 0.5 and 2.5 μm.

As can also be seen in FIG. 2C, in the third embodiment variant, the overlap length L₀ is at most 1.75 times as large as the finger spacing d₂ between an evaluation electrode finger 6b and an adjacent deflection electrode finger 5b. Furthermore, the finger length L₂ of the evaluation electrode finger 6b is at most three times as large as the first finger end spacing d₁, and the finger length L₁ of the deflection electrode finger 5b is at most three times as large as the second finger end spacing d₀. The finger length L₂ of the evaluation electrode fingers 6b and the finger length L₁ of the deflection electrode fingers can correspond to at least the finger spacing d₂, as shown. In addition, the overlap length L₀ is at most 1.75 times as large as the first finger end spacing d₁ and as the second finger end spacing d₀. The first finger end spacing d₁ and the second finger end spacing d₂ can be substantially the same. The first finger end spacing d₁ and the second finger end spacing d₀ can substantially correspond to the finger spacing d₂ or can be slightly larger, in particular can be dimensioned with a maximum deviation of between 25 and 50% corresponding to the extent of the finger spacing d₂.

As can be seen in FIG. 2C, the finger length L₂ of the evaluation electrode fingers 6b is at least as large and at most 1.5 times as large as a finger width b of the evaluation electrode fingers 6b perpendicular to their finger length L₂. In addition, the finger length L₁ of the deflection electrode fingers 5b is at least as large and at most 1.5. times as large as a finger width b of the deflection electrode fingers 5b perpendicular to their finger length L₁. The finger width b of the evaluation electrode fingers 6b and of the deflection electrode fingers 5b can be at least half and at most twice the overlap length L₀. As shown, a spacing between two successive deflection electrode fingers 5b can correspond to a maximum of twice the finger length L₁ of the deflection electrode fingers 5b, and/or a spacing between two successive evaluation electrode fingers 6b can, as shown, correspond to a maximum of twice the finger length L₂ of the evaluation electrode fingers 6b. According to the exemplary embodiment shown, the finger length L₁ of the deflection electrode fingers 5b is smaller than a diameter 5f of the deflection electrode bar 5a transverse to its main extent 5e. In addition, the finger length L₂ of the deflection electrode fingers 6b is smaller than a diameter 6f of the deflection electrode bar 6a transverse to its main extent 6e.

In the comb structure according to the related art shown in FIG. 2A, the spacings between the end surfaces 5c of the deflection electrode fingers 5b and the opposite evaluation electrode bars 6a, as well as the spacings between the end surfaces 6c of the evaluation electrode fingers 6b and the opposite deflection electrode bars 5a, are so large that the end surfaces 5c, 6c do not make a significant contribution to the capacitive sensor signal when the movable sensor structure 3 is deflected in the detection direction, so that only the change in the lateral overlap contributes to the signal. Due to the small finger end spacings d₁, d₀ illustrated in FIGS. 2B and 2C, the end surfaces 5c, 6c of the electrode fingers can in contrast contribute significantly to the capacitive detection signal so that a higher electrical sensitivity of the sensor component 1 can be achieved.

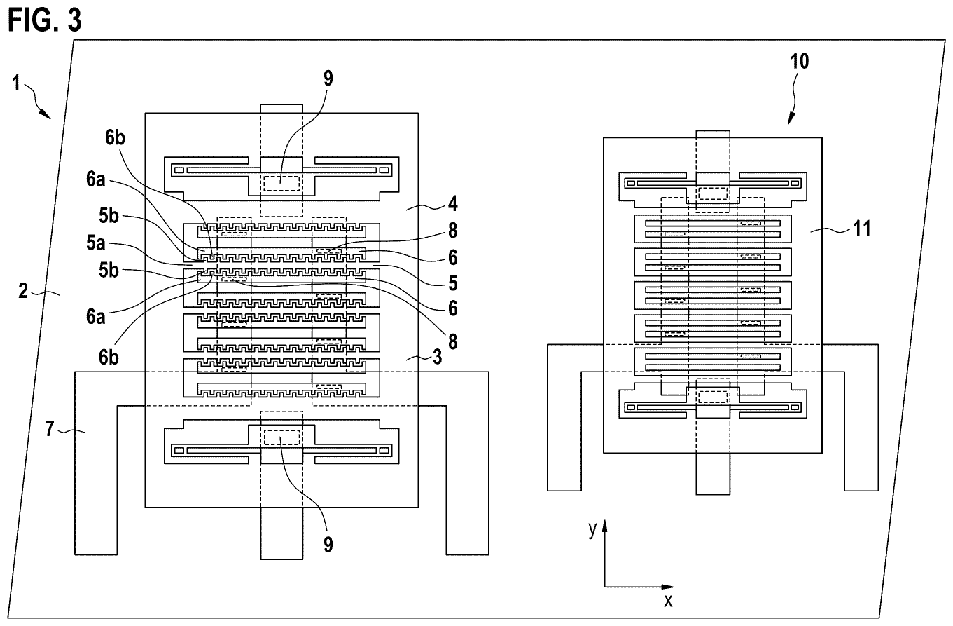

FIG. 3 shows a schematic diagram of a microelectromechanical sensor component 1 according to a second embodiment, which is comparable in its basic structure and its functioning to the microelectromechanical sensor component 1 according to the first embodiment. The microelectromechanical sensor component 1 shown in FIG. 3 has a sensor cavity (not shown in detail) in which the movable sensor structure 3 and the evaluation electrodes 6 are arranged, wherein a predefined gas pressure is set in the sensor cavity. Differing from the microelectromechanical sensor component 1 according to the first embodiment, a further sensor element 10 with a movable detection structure 11 for detecting an acceleration acting on the microelectromechanical sensor component 1 is arranged in the sensor cavity here. The movable sensor structure 3, the evaluation electrodes 6, and the further sensor element 10 are also arranged on a common substrate 2. As indicated in FIG. 3, the movable detection structure 11 of the further sensor element 10 is based on an electrode arrangement with simple electrode bars without a comb structure so that a squeeze film damping with high damping forces predominates in the further sensor element 10 when the movable detection structure 11 is deflected. The further sensor element 10 can accordingly be designed for high damping and can thus, for example, have a high robustness against vibration. Due to the above-described advantages of the proposed microelectromechanical sensor component 1, which include, for example, reduced mechanical noise due to the design-related reduced damping and, at the same time, high electrical sensitivity due to the change in spacing between the end surfaces of the electrode fingers and the electrode bars that can be detected in addition to the variable overlap length, the microelectromechanical sensor component 1 can also be operated with a further sensor element 10 in a strongly damped environment with high measurement accuracy, although the internal pressure of the sensor cavity would normally have to be greatly reduced to achieve low noise values. If the microelectromechanical sensor component 1 is intended for use in an earphone, for example, the movable sensor structure 3 with the evaluation electrodes 6 can form, for example, an acceleration sensor element for detecting bone conduction, while the further sensor element 10 represents a further vibration-robust acceleration sensor element configured, for example, to detect head rotation. The internal pressure in the sensor cavity can be increased to such an extent that the further acceleration sensor element, which is to be comparatively strongly damped, can be operated without problems, while the acceleration sensor element for detecting bone conduction still has a very low mechanical noise power density. Furthermore, the proposed microelectromechanical sensor component 1 can also be used for a bone conduction sensor in combination with a three-axis rotation rate sensor and a three-axis acceleration sensor, integrated on a common MEMS chip, in a common housing or in a common terminal device. The rotation rate sensor is generally placed in a separate sensor cavity with lower gas pressure, while the bone conduction sensor and the three-axis acceleration sensor are placed in a common sensor cavity.

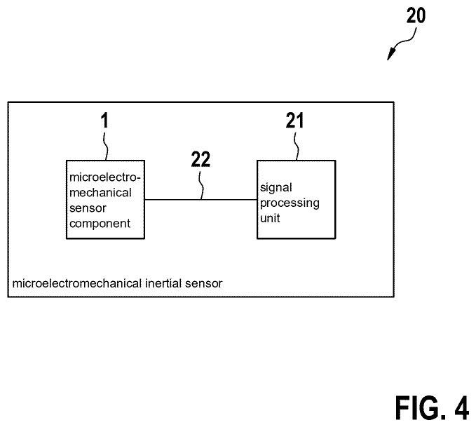

FIG. 4 is a schematic diagram of a microelectromechanical inertial sensor 20 having a microelectromechanical sensor component 1, which is connected via a signal connection 22 to a signal processing unit 21, for example designed as an ASIC, for applying and processing signals of the microelectromechanical sensor component 1. The microelectromechanical sensor component 1 can, for example, be designed according to one of the embodiments described above. The microelectromechanical inertial sensor 20 can be designed, for example, as an acceleration sensor for detecting a translational acceleration and/or as a rotation rate sensor for detecting a rotational acceleration. The microelectromechanical inertial sensor 20 can be designed to detect structure-borne sound and/or airborne sound, in particular to detect bone conduction. The microelectromechanical inertial sensor 20 makes it possible to obtain an inertial sensor 20 which is characterized by high measurement sensitivity and a favorable signal-to-noise ratio due to the implemented microelectromechanical sensor component 1 according to the described features. Due to its compact design and high sensitivity, reliable and comfortably usable sound detection, for example in wireless earphones or headsets, can be implemented.

What is claimed is:

1. A microelectromechanical sensor component, comprising:
a substrate;
a movable sensor structure connected to the substrate and having a seismic mass portion and a deflection electrode arranged thereon; and
at least one evaluation electrode arranged on the substrate, the deflection electrode of the movable sensor structure being arranged so as to be movable relative to the evaluation electrode, wherein the evaluation electrode is configured for capacitive detection of a deflection of the deflection electrode;
wherein:
the deflection electrode and the evaluation electrode form a comb structure in that the deflection electrode has a plurality of deflection electrode fingers extending from a deflection electrode bar in a direction of the evaluation electrode, and in that the evaluation electrode has a plurality of evaluation electrode fingers extending, parallel at least in portions to the deflection electrode fingers, from an evaluation electrode bar in a direction of the deflection electrode, and
(i) the deflection electrode fingers have a finger length in the direction of the evaluation electrode bar that corresponds to at most three times a finger spacing from a lateral surface of a deflection electrode finger to an opposite lateral surface of an adjacent evaluation electrode finger, and/or (ii) the evaluation electrode fingers have a finger length in the direction of the deflection electrode bar that corresponds at most to three times a finger spacing from a lateral surface of an evaluation electrode finger to an opposite lateral surface of an adjacent deflection electrode finger.

2. The microelectromechanical sensor component according to claim 1, the at least one evaluation electrode includes at least two evaluation electrodes arranged spaced apart from one another on the substrate, between which evaluation electrodes the deflection electrode of the movable sensor structure is movably arranged, and wherein the evaluation electrodes are configured for differential capacitive detection of a deflection of the deflection electrode.

3. The microelectromechanical sensor component according to claim 1, wherein adjacent evaluation electrode fingers and deflection electrode fingers have a defined overlap length parallel to one another in a rest state of the movable sensor structure, and wherein the overlap length is at most twice as large as the finger spacing between an evaluation electrode finger and an adjacent deflection electrode finger.

4. The microelectromechanical sensor component according to claim 1, wherein:
(i) in a rest state of the movable sensor structure, a defined first finger end spacing is present between an end surface of an evaluation electrode finger facing the deflection electrode bar and the deflection electrode bar, wherein the finger length of the evaluation electrode finger is at most four times as large as the first finger end spacing, and/or
(ii) in the rest state of the movable sensor structure, a defined second finger end spacing is present between an end surface of a deflection electrode finger facing the evaluation electrode bar and the evaluation electrode bar, wherein the finger length of the deflection electrode finger is at most four times as large as the second finger end spacing.

5. The microelectromechanical sensor component according to claim 1, wherein adjacent evaluation electrode fingers and deflection electrode fingers have a defined overlap length parallel to one another in a rest state of the movable sensor structure, and wherein:
(i) in a rest state of the movable sensor structure, a defined first finger end spacing is present between an end surface of an evaluation electrode finger facing the deflection electrode bar and the deflection electrode bar, wherein the overlap length is at most twice as large as the first finger end spacing, and/or
(ii) in the rest state of the movable sensor structure, a defined second finger end spacing is present between an end surface of a deflection electrode finger facing the evaluation electrode bar and the evaluation electrode bar, wherein the overlap length is at most twice as large as the second finger end spacing.

6. The microelectromechanical sensor component according to claim 5, wherein the finger spacing corresponds with a maximum deviation of 50% to the first finger end spacing and/or to the second finger end spacing.

7. The microelectromechanical sensor component according to claim 1, wherein the first finger end spacing corresponds with a maximum deviation of 50% to the second finger end spacing.

8. The microelectromechanical sensor component according to claim 1, wherein: (i) the finger length of the evaluation electrode fingers is at most twice as large as a finger width of the evaluation electrode fingers perpendicular to their finger length, and/or (ii) the finger length of the deflection electrode fingers is at most twice as large as a finger width of the deflection electrode fingers perpendicular to their finger length.

9. The microelectromechanical sensor component according to claim 1, wherein: (i) the finger length of the evaluation electrode fingers is at least as large as the finger width of the evaluation electrode fingers perpendicular to their finger length, and/or (ii) the finger length of the deflection electrode fingers is at least as large as the finger width of the deflection electrode fingers perpendicular to their finger length.

10. The microelectromechanical sensor component according to claim 1, wherein the finger width of the evaluation electrode fingers and/or of the deflection electrode fingers is at least half and at most twice the overlap length.

11. The microelectromechanical sensor component according to claim 1, wherein: (i) the finger length of the evaluation electrode fingers corresponds to at least the finger spacing from a lateral surface of the evaluation electrode finger to an opposite lateral surface of an adjacent deflection electrode finger, and/or (ii) the finger length of the deflection electrode fingers corresponds at least to the finger spacing from a lateral surface of the deflection electrode finger to an opposite lateral surface of an adjacent evaluation electrode finger.

12. The microelectromechanical sensor component according to claim 1, wherein: (i) a spacing between two successive deflection electrode fingers is at most twice the finger length of the deflection electrode fingers, and/or (ii) a spacing between two successive evaluation electrode fingers is at most twice the finger length of the evaluation electrode fingers.

13. The microelectromechanical sensor component according to claim 1, wherein the finger spacing is between 0.5 and 2.5 μm.

14. The microelectromechanical sensor component according to claim 1, wherein: (i) the finger length of the deflection electrode fingers is smaller than a diameter of the deflection electrode bar transverse to its main extent, and/or (ii) the finger length of the evaluation electrode fingers is smaller than a diameter of the evaluation electrode bar transverse to its main extent.

15. The microelectromechanical sensor component according to claim 1, wherein the movable sensor structure is configured to deflect the deflection electrode in such a way that the deflection electrode bar is movable toward the evaluation electrode bar.

16. The microelectromechanical sensor component according to claim 1, wherein the microelectromechanical sensor component has a sensor cavity in which the movable sensor structure and the evaluation electrode are arranged, wherein a predefined gas pressure is set in the sensor cavity.

17. The microelectromechanical sensor component according to claim 16, wherein a further sensor element with a movable detection structure for detecting an acceleration acting on the microelectromechanical sensor component is arranged in the sensor cavity.

18. The microelectromechanical sensor component according to claim 1, wherein the microelectromechanical sensor component has a plurality of movable sensor structures and associated evaluation electrodes.

19. A microelectromechanical inertial sensor, comprising:
a microelectromechanical sensor component; and
a signal processing unit configured to apply and processing signals of the microelectromechanical sensor component;
wherein the microelectromechanical sensor component includes:
a substrate;
a movable sensor structure connected to the substrate and having a seismic mass portion and a deflection electrode arranged thereon; and
at least one evaluation electrode arranged on the substrate, the deflection electrode of the movable sensor structure being arranged so as to be movable relative to the evaluation electrode, wherein the evaluation electrode is configured for capacitive detection of a deflection of the deflection electrode;
wherein:
the deflection electrode and the evaluation electrode form a comb structure in that the deflection electrode has a plurality of deflection electrode fingers extending from a deflection electrode bar in a direction of the evaluation electrode, and in that the evaluation electrode has a plurality of evaluation electrode fingers extending, parallel at least in portions to the deflection electrode fingers, from an evaluation electrode bar in a direction of the deflection electrode, and
(i) the deflection electrode fingers have a finger length in the direction of the evaluation electrode bar that corresponds to at most three times a finger spacing from a lateral surface of a deflection electrode finger to an opposite lateral surface of an adjacent evaluation electrode finger, and/or (ii) the evaluation electrode fingers have a finger length in the direction of the deflection electrode bar that corresponds at most to three times a finger spacing from a lateral surface of an evaluation electrode finger to an opposite lateral surface of an adjacent deflection electrode finger.

20. The microelectromechanical inertial sensor according to claim 19, wherein the microelectromechanical inertial sensor is configured to detect structure-borne sound, and/or airborne sound.
